(19) United States
(12) Patent Application Publication
(10) Pub. No.: US 2016/0151845 A1
(43) Pub. Date: Jun. 2, 2016

(54) RECIPROCATING ELECTRIC POWER TOOL

(71) Applicant: MAKITA CORPORATION, Anjo-shi, Aichi (JP)

(72) Inventors: Hirokatsu YAMAMOTO, Anjo-shi (JP); Takaaki OSADA, Anjo-shi (JP); Yasushi OGURA, Anjo-shi (JP)

(73) Assignee: MAKITA CORPORATION, Anjo-shi, Aichi (JP)

(21) Appl. No.: 14/904,240

(22) PCT Filed: Mar. 31, 2014
(86) PCT No.: PCT/JP2014/059527

§ 371 Date: Jan. 11, 2016

(30) Foreign Application Priority Data
Jul. 24, 2013 (JP) 2013-153778

(51) Int. Cl. B23D 59/00; B23D 51/16; B23D 49/16

(52) U.S. Cl. CPC B23D 59/001; B23D 49/16; B23D 51/16

(57) ABSTRACT

A reciprocating electric power tool in one aspect of the present invention includes an attachment unit, a motor, a power transmission unit, and a controller. The controller is configured to operate the motor at a first speed when activated; to operate the motor at a second speed that is higher than the first speed when a first condition is satisfied after activation; and, to operate the motor at a third speed that is higher than the second speed when a second condition is satisfied after the first condition is satisfied.

### CROSS-REFERENCE TO RELATED APPLICATIONS

This international application claims the benefit of Japanese Patent Application No. 2013-153778 filed Jul. 24, 2013 in the Japan Patent Office, and the entire disclosure thereof is incorporated herein by reference.

### TECHNICAL FIELD

The present invention relates to a reciprocating electric power tool for processing a work piece by reciprocating a tool bit such as a saw blade.

### BACKGROUND ART

Among reciprocating electric power tools such as reciprocating saws and jigsaws, one that is configured to decrease a rotational speed of a motor that reciprocates a blade (a saw blade) when the motor is in no-load condition (in other words, when the blade is not in contact with a work piece) is known (for example, see, Patent Document 1).

This type of reciprocating electric power tool can reduce oscillation of the reciprocating electric power tool and reduce a sound or a radio noise that occurs from the reciprocating electric power tool by decreasing the rotational speed of the motor at the time of no-load operation.

### PRIOR ART DOCUMENTS

### Patent Documents

Patent Document 1: U.S. Pat. No. 4,002,959

### SUMMARY OF THE INVENTION

### Problems to be Solved by the Invention

When the blade, which is a tool bit, comes into contact with the work piece and the motor is loaded in the aforementioned reciprocating electric power tool, the rotational speed of the motor is increased immediately to a certain processing speed or to a command speed, which is set in accordance with a pulled amount of a trigger switch operated by a user, to increase an output power.

Such immediate increase of the speed in the aforementioned conventional reciprocating electric power tool sometimes made processing of the work piece difficult for the user.

In other words, since the blade is being reciprocated in the aforementioned reciprocating electric power tool, the blade oscillates in a direction perpendicular to its axis of reciprocation (more specifically, in a direction perpendicular to a plate surface of the blade) when the rotational speed of the motor increases.

Such oscillation is not problematic if there is an incision formed on the work piece to accommodate an edge of the blade; however, if there is no incision on the work piece when cutting an iron pipe, for example, then the blade slips on the surface of the work piece and fails to process the work piece well.

It is preferable that one aspect of the present invention can provide a reciprocating electric power tool that can start processing a work piece without experiencing a slip of a tool bit, such as a blade, on a surface of the work piece when the processing starts with the tool bit being in contact with the work piece; and that can swiftly complete the process once the processing is started.

### Means for Solving the Problems

A reciprocating electric power tool in one aspect of the present invention comprises an attachment unit to which a tool bit is attached. This attachment unit is coupled to a motor via a power transmission unit; the attachment unit reciprocates by rotations of the motor, and causes the tool bit to reciprocate.

The motor is operated by a controller. In other words, the controller operates the motor at a first speed when activated by a command from outside, and operates the motor at a second speed that is higher than the first speed when a first condition is satisfied after the activation, and operates the motor at a third speed that is higher than the second speed when a second condition is satisfied after the first condition is satisfied.

The controller of such a reciprocating electric power tool increases a rotational speed of the motor stepwise in three steps (or more steps) from the first speed, the second speed, to the third speed as such, in accordance with a specified drive condition (the first condition or the second condition) when a drive command to the electric power tool is inputted from outside.

According to the reciprocating electric power tool as mentioned above, the work piece can thus be effectively processed after activation, and the time needed for processing the work piece can be reduced compared to a conventional device where the rotational speed of the motor is switched between two modes: a mode for a no-load time and for a normal time.

In other words, according to the reciprocating electric power tool as mentioned above, controls as below will be possible:

(1) reduce the consumed electric power at the time of no-load operation by driving the motor at the first speed, which is the lowest speed, during the time of no-load operation that is from the time of activating the controller and starting the motor drive to the time of having the tool bit come into contact with the work piece and starting the process;

(2) reciprocate the tool bit to form an incision on the work piece while reducing the occurrence of oscillation to the tool bit in a direction perpendicular to a reciprocating direction of the tool bit (in other words, reducing slips of the tool bit on a surface of the work piece) by driving the motor at the second speed, which is lower than the rotational speed for a normal process, when starting processing the work piece by the tool bit; and,

(3) process the work piece in a short time by driving the motor at the rotational speed for the normal process, when the load on the motor increases furthermore as a user presses the tool bit against the work piece to process the work piece after the incision is formed on the work piece.

The condition for the controller to switch the rotational speed of the motor (the first condition or the second condition) may be set in accordance with a state quantity (specifically, a first threshold value or a second threshold value) that indicates the load state of the motor detected by a load-state detection unit.

As a result, the rotational speed of the motor can be controlled in accordance with the processing state of the work piece by the tool bit, and the above-described controls (1) to (3) can be performed automatically by switching the rotational speed of the motor stepwise in accordance with the load applied to the motor.

In the above case, the user does not need to manually adjust the rotational speed of the motor in accordance with the processing state of the work piece; thus, a performance of processing the work piece can be improved.

The condition for the controller to switch the rotational speed of the motor (the first condition or the second condition) may also be set in accordance with a drive time of the motor (specifically, the first-time or the second-time).

This eliminates a need for detection of the load state by the load-state detection unit and makes a device configuration simple; thus, the cost can be reduced.

In addition, considering that a time required for the above-mentioned controls (1) and (2) may be approximately constant, the performance of processing the work piece can be improved if the first-time and the second-time are appropriately set upon processing a particular work piece.

The reciprocating electric power tool as mentioned above may comprise a speed-setting unit that sets the rotational speed of the motor. The controller may limit the rotational speed of the motor to the rotational speed set by the speed-setting unit or lower when operating the motor, regardless of whether the first condition or the second condition is satisfied.

In the above case, there are reduced occasions where the motor is operated at a speed exceeding the rotational speed set by the user via the speed-setting unit; thus, the user can safely use the reciprocating electric power tool.

If the state quantity, which indicates the load state of the motor, decreases to the third threshold value that is equal to or lower than the first threshold value when operating the motor at the third speed, then the controller may operate the motor at the first speed.

In this case, once the rotational speed of the motor is increased to the third speed, the drive of the motor is continued without decreasing the speed of the motor until the state quantity decreases to the third threshold value thereafter.

This reduces an occurrence of an unexpected processing on the work piece for the user, resulting from a fall of the rotational speed of the motor from the third speed to the second speed, when a sudden release of the user's tension during processing the work piece caused a decrease in the state quantity down to the second threshold value.

In brief, according to the reciprocating electric power tool as configured above, the rotational speed of the motor is maintained at the third speed; thus, the work piece will be easily processed as intended by the user.

The controller may continue the operation of the motor until an operation-stop command for the motor is inputted and may stop the operation of the motor once the operation-stop command for the motor is inputted, when operating the motor at the third speed.

For example, when cutting the work piece as drawing a curve with a jigsaw or the like, the blade, which is the tool bit, is occasionally removed from the work piece for a moment to change an angle of the blade in relation to the work piece; during such a moment, the motor is in no-load condition.

In this case, if the rotational speed of the motor is decreased to the first speed every time when the motor is in no-load condition as in the above case, then the performance of processing is noticeably degraded for the user.

Thus, in the reciprocating electric power tool as mentioned above, once the rotational speed of the motor reaches the third speed, which is a processing speed of the work piece, degradation of the performance of processing the work piece is reduced by maintaining the rotational speed of the motor at the third speed until the operation-stop command for the motor is inputted.

Next, the controller may operate the motor at the second speed when the state quantity that indicates the load state of the motor decreases to the fourth threshold value, which is equal to the second threshold value or between the second threshold value and the third threshold value, when operating the motor at the third speed.

The controller may operate the motor at the first speed when the state quantity that indicates the load state of the motor decreases to the third threshold value, which is equal to or lower than the first threshold value, when operating the motor at the second speed.

According to the reciprocating electric power tool as configured above, when the load applied to the motor decreases, the rotational speed of the motor can be decreased stepwise in the reverse direction of the steps for when the load applied to the motor increases.

Thus, a sharp decrease of the rotational speed of the motor is therefore reduced according to the reciprocating electric power tool as configured above; accordingly, the performance of processing can be improved by, for example, reducing the oscillation of the tool bit that is caused when repeatedly processing the work piece.

The controller may operate the motor at the first speed when the elapsed time for operating the motor at the third speed reaches a preset time.

In this case, the processing of the work piece can be completed by decreasing the rotational speed of the motor without detecting the load state of the motor when processing the work piece, for which a time required for the above-mentioned control (3) is approximately constant; thereby, the performance of processing the work piece can be improved.

In addition, since the detection of the load state by the load-state detection unit is not required, the device configuration can be simplified thereby to reduce the cost.

The reciprocating electric power tool as mentioned above may comprise a control-parameter setting unit that sets a control parameter (such as the first condition, the second condition, the first speed, the second speed, or the third speed) from outside; the control parameter is used by the controller to control the operation of the motor.

In this case, the user can appropriately set the controller's control operation for the motor to a desired control operation; thus, the user can experience an improved usability.

The controller may be configured to be operable also in a normal mode where the motor is operated at a specified rotational speed in accordance with a command from outside, in addition to a control mode where the rotational speed of the motor is switched in accordance with the above-mentioned first condition or second condition.

The reciprocating electric power tool may comprise an operation-setting unit that sets an operational mode of the controller either to the control mode or to the normal mode.

Thereby, if the user sets the operational mode of the controller to the normal mode via the operation-setting unit, then the motor can be driven at a desired rotational speed in accordance with, for example, a pulled amount of a trigger switch, and the rotational speed of the motor is inhibited from being automatically adjusted by an operation of the controller. Thus, the reciprocating electric power tool as mentioned above can serve as a more useable electric power tool for the user.

The above-mentioned reciprocating electric power tool may comprise a trigger switch. The trigger switch may be configured to issue a command for rotational speed of the motor to the controller in accordance with a pulled amount of the trigger switch, as well as a command for operation of the motor. The trigger switch may comprise a lock-on function that holds the trigger switch with the maximum pulled amount.

The reciprocating electric power tool as configured above enables the rotational speed of the motor to be switched stepwise after activation: i.e., from the first speed, to the second speed, to the third speed . . . ; thus, a subtle adjustment of the speed by the trigger switch can be made unnecessary.

Further, even if the trigger switch is equipped with the lock-on function that holds the trigger switch at the maximum pulled amount, the work piece can be efficiently processed and an operation required for processing the work piece can be efficiently performed with the reciprocating electric power tool as mentioned above.

In addition, a load-state detection unit may calculate the state quantity that indicates the load state of the motor by using at least one of the current, the rotational speed, or the torque of the motor. The reciprocating electric power tool typically comprises one or more sensors to monitor the current, the rotational speed, the torque or the like of the motor. By using at least one of such operating quantities obtained from these sensors to calculate the state quantity that indicates the load state, the cost can be reduced and a circuit can be downsized without any additional sensor.

### BRIEF DESCRIPTION OF THE DRAWINGS

FIG. 1 is an explanatory drawing illustrating a schematic configuration of a reciprocating saw in an exemplary embodiment;

FIGS. 2A-2C are explanatory drawings illustrating configurations of an operation-setting unit that sets an operational mode;

FIG. 3 is a timing chart illustrating a control operation of a motor in a first mode;

FIG. 4 is a timing chart illustrating a control operation of the motor in a second mode;

FIG. 5A is a flowchart illustrating a part of a drive-control process of the motor in the second mode;

FIG. 5B is a flowchart illustrating the rest of the drive-control process;

FIGS. 6A-6B are explanatory drawings of movements of a blade when cutting a metallic pipe, FIG. 6A illustrating a movement of the blade in the first mode, and FIG. 6B illustrating movements of the blade in the second mode;

FIG. 7 is an explanatory drawing illustrating a variation of the operation-setting unit;

FIG. 8 is an explanatory drawing illustrating an example of a control-parameter setting unit;

FIG. 9 is a timing chart illustrating a first variation of the control operation in FIG. 4;

FIG. 10 is a timing chart illustrating a second variation of the control operation in FIG. 4;

FIG. 11 is a timing chart illustrating a third variation of the control operation in FIG. 4;

FIG. 12 is a timing chart illustrating a fourth variation of the control operation in FIG. 4.

### EXPLANATION OF REFERENCE NUMERALS

2 . . . reciprocating saw, 3 . . . grip portion, 4 . . . tool body, 6 . . . battery, 8 . . . blade holder, 9 . . . blade, 10 . . . motor, 12 . . . power transmission unit, 14 . . . drive circuit, 16 . . . trigger switch, 17 . . . lock-on mechanism, 18 . . . monitor circuit, 20 . . . controller, 22 . . . operation-setting unit, 24 . . . operation unit, 30 . . . control-parameter setting unit, 32 . . . numeric display unit, 33, 34 . . . operation push-button

### Mode for Carrying out the Invention

An exemplary embodiment of the present invention is described hereinafter with reference to the drawings.

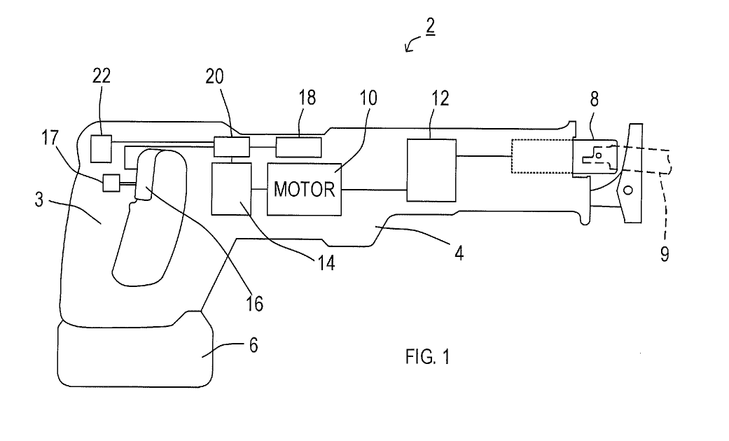

In the present embodiment, the present invention is applied to a reciprocating saw 2 as shown in FIG. 1. The reciprocating saw 2 comprises a tool body 4 in an elongated shape, on one end (the left of FIG. 1) of which a grip portion 3 is formed to provide a grip for a user; and, a battery 6 that is detachably attached below the grip portion 3 on the tool body 4.

The grip portion 3 on the tool body 4 comprises a trigger switch 16 that is used to input a drive command for the reciprocating saw 2 while the user is holding the grip portion 3.

Another end of the tool body 4 (the right of FIG. 1), which is opposite to the end where the grip portion 3 is formed, is provided with a blade holder 8 where a blade 9 is attached as a tool bit.

The tool body 4 internally comprises a motor 10; a power transmission unit 12 that converts a rotation of the motor 10 into a reciprocating motion and transmits the reciprocating motion to the blade holder 8; and a drive circuit 14 that receives power supply from the battery 6 and supply current to the motor 10 as drive-system components to reciprocate the blade holder 8 (thus, the blade 9).

The tool body 4 also internally comprises a monitor circuit 18; a controller 20; and an operation-setting unit 22 as control-system components to control the rotational speed of the motor 10 (thus, the reciprocating speed of the blade 9) via the drive circuit 14.

The monitor circuit 18 estimates, as state quantities that indicate the load state of the motor 10, a torque τ that acts on the motor 10 and a rotational speed ω of the motor 10 based on a current i that flows in the motor 10 and a voltage V that is applied to the motor 10.

Based on the voltage V applied to the motor 10 and an estimated value τe of the torque τ, the monitor circuit 18 estimates the rotational speed ω and the current i by using a double input-double output motor model M, in which the voltage V and the torque τ are used as the inputs and the rotational speed ω and the current i are used as the outputs.

A difference Δi (=i−ie) between an estimated value ie of the current i from the estimation and the current i that actually flows in the motor 10 is then multiplied by a specified gain G, and the result is fed back to the motor model M. This feedback value is used as an estimated value τe of the torque τ.

The torque τ and the rotational speed ω of the motor 10 can thus be estimated based on the current i and voltage V of the motor 10 as a result of using the monitor circuit 18.

This estimating procedure is included in an earlier application (Japanese Patent Application No. JP2011-027787) filed by the applicant of the present application, and the detail of the procedure is described in the international publication of this earlier application (WO 20121/108246 A1). The disclosure of WO 20121/108246 A1 is incorporated herein by reference; any further explanation of the estimating procedure is thereby omitted.

The controller 20 drive-controls the motor 10 via the drive circuit 14 in accordance with the drive command inputted by the user through operating the trigger switch 16, and comprises a microcomputer comprising a CPU, ROM, RAM, or the like.

The controller 20 operates in a normal mode, in which the controller 20 controls the rotational speed ω of the motor 10 in accordance with a pulled amount of the trigger switch 16, or in a control mode (a first mode or a second mode), in which the controller 20 controls the rotational speed ω of the motor 10 stepwise in two or three steps, when the trigger switch 16 is operated and is in the ON state.

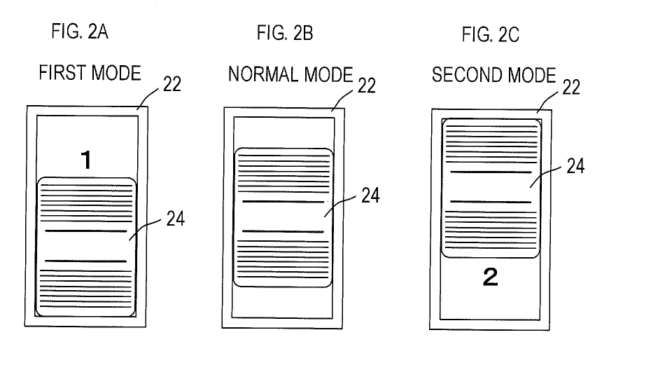

The operation-setting unit 22 is used by the user to set the operational mode of the reciprocating saw 2 to any of the normal mode, the first mode, or the second mode; the operation-setting unit 22 is configured with, for example, a selector switch by which the position of an operation unit 24 can be switched between three modes as shown in FIGS. 2A to 2C.

The controller 20 operates in accordance with an operational mode set by the user via the operation-setting unit 22, and controls an actual rotational speed of the motor 10 based on the torque τ and the rotational speed ω estimated by the monitor circuit 18 when the operational mode is being set to the control mode.

Among the modes of the control mode, the first mode is suitable for a cutting-processing of a wood with the reciprocating saw 2, and the second mode is suitable for a cutting-processing of a metal material with the reciprocating saw 2.

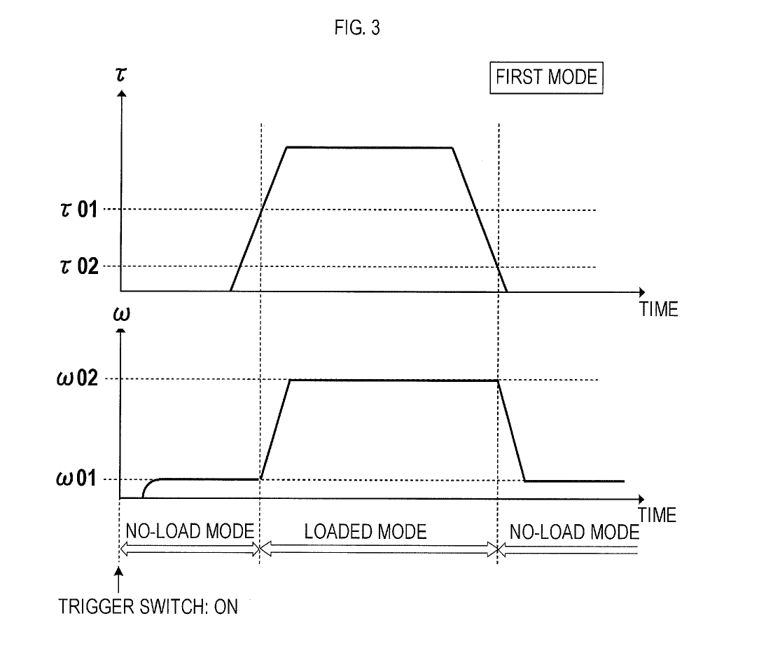

The controller 20 determines that the motor 10 is in no-load condition until the torque τ applied to the motor 10 reaches a threshold value τ01 and controls the rotational speed ω of the motor 10 to be a target speed ω01 in a no-load mode as shown in FIG. 3 when the operational mode is being set to the first mode.

The controller 20 controls the rotational speed ω of the motor 10 to be the target speed ω02 in a loaded mode when the torque τ applied to the motor 10 exceeds the threshold value τ01 (specifically, when the blade 9 comes into contact with the wood and the load on the motor 10 increases).

The controller 20 determines that the processing of the wood, which is a work piece, is completed and controls the rotational speed ω of the motor 10 to be the target speed ω01 in the no-load mode when the torque τ applied to the motor 10 decreases to a threshold value τ02 that is smaller than the threshold value τ01 after exceeding the threshold value τ01 once.

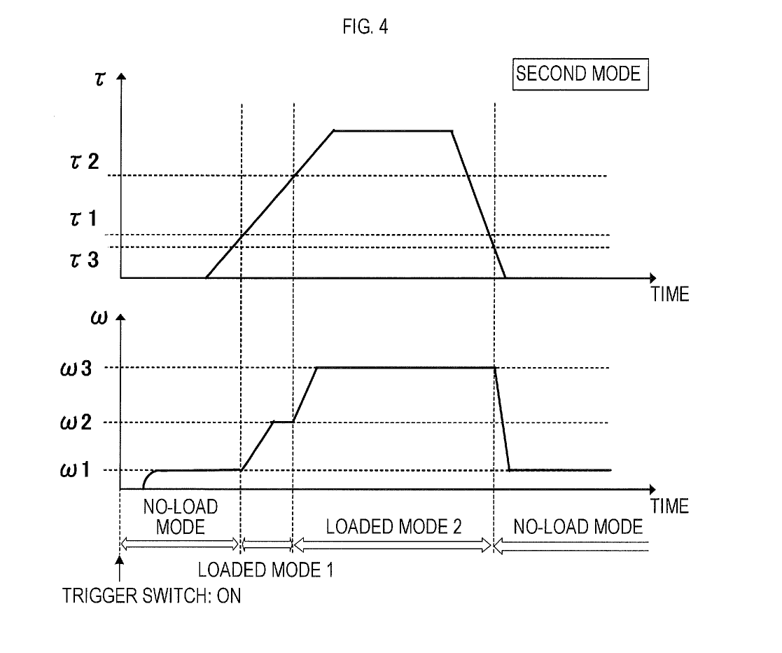

The controller 20 determines that the motor 10 is in no-load condition until the torque τ applied to the motor 10 reaches the first threshold value τ1 and controls the rotational speed ω of the motor 10 to be a target speed (the first speed) ω1 for the metal material in the no-load mode as shown in FIG. 4 while the operational mode is set to the second mode.

When the torque τ applied to the motor 10 exceeds the first threshold value τ1, the controller 20 determines that the blade 9 comes into contact with the metal material and controls the rotational speed ω of the motor 10 to be the target speed (the second speed ω2) in a loaded mode 1 in which the blade 9 forms an incision on the metal material.

The controller 20 determines that the incision is formed on the metal material and the user firmly presses the blade 9 against the metal material when the torque τ applied to the motor 10 exceeds the second threshold value τ2 that is greater than the first threshold value τ1 after exceeding the first threshold value τ1; and then accelerates the drive-speed of the blade 9.

In other words, since the load applied to the motor 10 from the blade 9 (that is, the torque τ) increases in this case, the controller 20 determines that the metal material needs a cutting-processing and controls the rotational speed ω of the motor 10 to be the target speed (the third speed ω3) in the loaded mode 2, in which the metal material is cut.

The controller 20 determines that the processing of the metal material, which is the work piece, is completed and controls the rotational speed ω of the motor 10 to be the first speed ω1 when the torque τ applied to the motor 10 decreases to the third threshold value Υ3 that is smaller than the first threshold value τ1 after exceeding the second threshold value τ2.

Note that the controller 20 sets an upper limit of the rotational speed ω of the motor 10 so as to restrain or prevent the rotational speed ω of the motor 10 from exceeding the rotational speed that is set in accordance with the pulled amount of the trigger switch 16 in the normal mode when the operational mode is in the control mode (the first mode or the second mode).

The rotational speed ω of the motor is thereby set to zero (0) even in the no-load mode during the period from when the trigger switch 16 is in the ON state by the user's operation of the trigger switch 16 until when the pulled amount of the trigger switch 16 reaches to a pulled amount that rotates the motor 10 (see FIG. 3 and FIG. 4).

This is to restrain the rotational speed ω of the motor 10 from exceeding a rotational speed intended by the user and giving the user a sense of awkwardness.

Regardless of which mode the operational mode is set to, when the pulled amount of the trigger switch 16 by the user increases to start the drive of the motor 10, the target speed of the motor 10 is not set to a control-speed, which is set in accordance with the pulled amount of the trigger switch 16, or to the first speed ω1 in the no-load mode; the target speed of the motor 10 is gradually increased to the control-speed, or to the first speed ω1 (see FIG. 3 and FIG. 4).

This is to restrain a sudden rise of the rotation of the motor 10 from applying an impact on the user's hand by performing a so-called soft-start, in which the rotational speed ω of the motor 10 is gradually increased at the time of starting the drive of the motor 10.

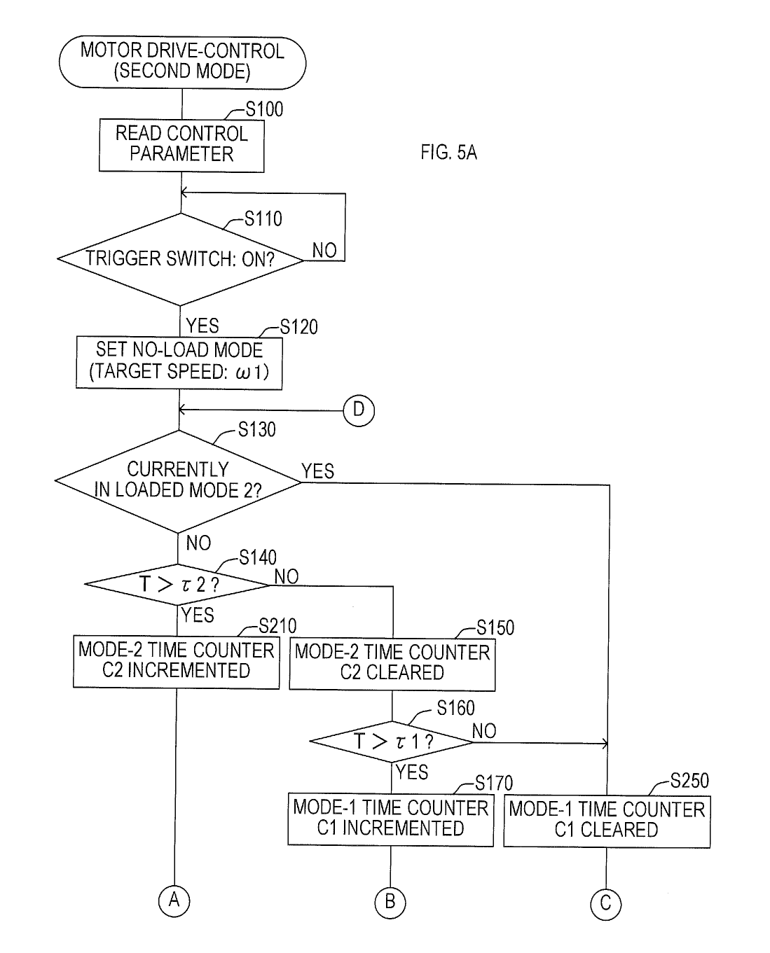

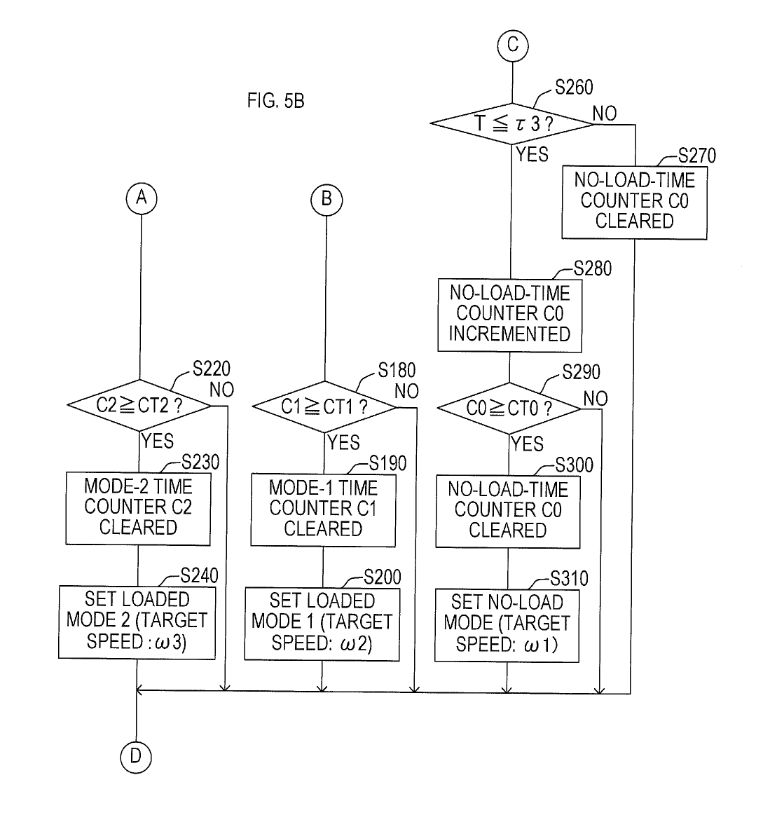

Among the drive-control process of the motor 10 performed by the controller 20 as mentioned above, the drive-control process in the second mode, which is a primary process of the present invention, is explained next with reference to the flowcharts shown in FIGS. 5A and 5B.

When this process is started, a control parameter (specifically, the threshold value τ1, τ2, or τ3 of the torque τ; the first speed ω1, the second speed ω2, the third speed τ3; or the like), which is used for controlling the rotational speed ω of the motor 10 in the second mode, is read in S100 (S stands for a step) as shown in FIGS. 5A and 5B.

The process then waits in S110 until the user operates the trigger switch 16 while it determines whether the trigger switch 16 is in the ON state. The process proceeds to S120 when the trigger switch 16 is operated and thus in the ON state; the loaded mode for driving the motor is set to the no-load mode by setting the target speed of the motor 10 to the first speed ω1.

The controller 20 sets a control amount of the motor 10 such that the rotational speed ω of the motor 10 estimated at the monitor circuit 18 is the first speed ω1 and starts the drive of the motor 10 by the drive circuit 14 when the mode is set to the no-load mode in S120.

It is then determined in S130 whether the loaded mode for driving the motor is set to the loaded mode 2 at a given moment. If the loaded mode for driving the motor is not set to the loaded mode 2 at the given moment, then the process proceeds to 5140.

In S140, the torque τ of the motor 10 is read from the monitor circuit 18; it is then determined whether the torque τ of the motor 10 exceeds the second threshold value τ2.

If the torque τ of the motor 10 does not exceed the second threshold value τ2, then the process proceeds to S150 and a mode-2 time counter C2 is cleared. And in the next S160, the torque τ of the motor 10 is read from the monitor circuit 18; it is then determined whether the read value exceeds the first threshold value τ1.

If it is determined in S160 that the torque τ of the motor 10 exceeds the first threshold value τ1, then the process proceeds to S170 to increment a mode-1 time counter C1; the process then proceeds to S180.

It is determined in S180 whether a value of the mode-1 time counter C1, which is incremented in S170, is equal to or greater than a preset count value CT1.

If it is determined in S180 that the mode-1 time counter C1 is not equal to or greater than the count value CT1, then the process proceeds to S130; if it is determined in S180 that the mode-1 time counter C1 is equal to or greater than the count value CT1, then the process proceeds to S190.

The mode-1 time counter C1 is cleared in S190, and the loaded mode for driving the motor is set to the loaded mode 1 in the next S200; then, the process proceeds to S130.

If the mode is set to the loaded mode 1 in S200, then the controller 20 changes the control amount of the motor 10 such that the rotational speed ω of the motor 10 estimated at the monitor circuit 18 is the second speed ω2, and switches the drive-speed of the motor 10 by the drive circuit 14 to the second speed ω2.

The mode-1 time counter C1 as mentioned above is used to confirm that the torque τ exceeds the first threshold value τ1 for a specified time decided based on the counted value CT1 or longer when changing the loaded mode for driving the motor to the loaded mode 1; the mode-1 time counter C1 functions as a so-called low pass filter to eliminate noise.

Consequently, even if a temporary error occurs in the estimation of the torque τ by the monitor circuit 18, it is possible to determine that the torque τ of the motor 10 exceeds the first threshold value τ1 and set the target speed for driving the motor 10 to the second speed ω2 without being influenced by such error.

If it is determined in S140 that the torque τ of the motor 10 exceeds the second threshold value τ2, the process then proceeds to S210 to increment the mode-2 time counter C2, and proceeds to S220.

It is determined in S220 whether a value of the mode-2 time counter C2, which is incremented in S210, is equal to or greater than a preset count value CT2.

If it is determined in S220 that the mode-2 time counter C2 is not equal to or greater than the count value CT2, then the process proceeds to S130; if it is determined in S220 that the mode-2 time counter C2 is equal to or greater than the count value CT2, then the process proceeds to S230.

The mode-2 time counter C2 is cleared in S230. And in the subsequent S240, the loaded mode for driving the motor is then set to the loaded mode 2. The process then proceeds to S130.

If the mode is set to the loaded mode 2 in S240, then the controller 20 changes the control amount of the motor 10 such that the rotational speed ω of the motor 10 estimated at the monitor circuit 18 is the third speed ω3, and switches the drive-speed of the motor 10 by the drive circuit 14 to the third speed ω3.

The mode-2 time counter C2 as mentioned above is used to confirm that the torque τ exceeds the second threshold value τ2 for a specified time, decided based on the count value CT2, or longer when changing the loaded mode for driving the motor to the loaded mode 2; the mode-2 time counter C2 functions as a so-called low pass filter to eliminate noise.

Consequently, even if a temporary error occurs in the estimation of the torque τ of the monitor circuit 18, it is possible to determine that the torque τ of the motor 10 exceeds the second threshold value τ2 and set the target speed for driving the motor 10 to the third speed ω3 without being influenced by such error.

Next, if it is determined in S160 that the torque τ of the motor 10 does not exceed the first threshold value τ1, then the process proceeds to S250 to clear the mode-1 time counter C1.

In the subsequent S260, the torque τ of the motor 10 is read from the monitor circuit 18; it is then determined whether the read value is equal to or smaller than the third threshold value τ3.

If it is determined in S260 that the torque τ of the motor 10 is greater than the third threshold value τ3, then a no-load-time counter C0 is cleared in S270 and the process proceeds to S130.

If it is determined in S260 that the torque τ of the motor 10 is equal to or smaller than the third threshold value τ3, then the process proceeds to S280 to increment the no-load-time counter C0, and then proceeds to S290.

It is determined in S290 whether a value of the no-load-time counter C0, which is incremented in S280, is equal to or greater than a preset count value CT0.

If it is determined in S290 that the no-load-time counter C0 is not equal to or greater than the count value CT0, then the process proceeds to S130; if it is determined in S290 that the no-load-time counter C0 is equal to or greater than the count value CT0, then the process proceeds to S300.

The no-load-time counter C0 is cleared in S300. And in the subsequent S310, the loaded mode for driving the motor is set to the no-load mode. The process then proceeds to S130.

If the mode is set to the no-load mode in S310, then the controller 20 changes the control amount of the motor 10 such that the rotational speed ω of the motor 10 estimated at the monitor circuit 18 is the first speed ω1, and switches the drive-speed of the motor 10 by the drive circuit 14 to the first speed ω1.

The no-load-time counter C0 as mentioned above is used to confirm that the torque τ is equal to or smaller than the third threshold value τ3 for a specified time, decided based on the count value CT0, or longer when changing the loaded mode for driving the motor from the loaded mode 2 to the no-load mode; the no-load-time counter C0 functions as a so-called low pass filter to eliminate noise.

Consequently, even if a temporary error occurs in the estimation of the torque τ of the monitor circuit 18, it is possible to determine that the torque τ of the motor 10 is equal to or smaller than the third threshold value τ3 and change the target speed for driving the motor 10 from the third speed ω3 to the first speed ω1 without being influenced by such error.

As it has been explained above, the drive-control of the motor 10 is performed in accordance with the operational mode that is set via the operation-setting unit 22 when the user operates the trigger switch 16 of the reciprocating saw 2 in the present embodiment.

The motor 10 is driven at the rotational speed which is in accordance with the pulled amount (operated amount) of the trigger switch 16 when the operational mode is set to the normal mode. The user can thereby rotate the motor 10 in accordance with the operated amount of the trigger switch 16 by setting the operational mode of the reciprocating saw 2 to the normal mode.

The rotation of the motor 10 is controlled stepwise in two steps, the target speed ω01 and the target speed ω02, based on the state quantity (the torque τ in the present embodiment) that indicates the load state of the motor 10 when the operational mode is set to the first mode.

Likewise the conventional art described above, the first mode enables things such as driving the motor 10 at a low speed in the no-load time during which the blade 9 is not in contact with the work piece; and driving motor 10 at a high speed when the blade 9 comes into contact with the work piece and the work piece needs to be processed.

In this first mode, the time required to cut a wood, which is the work piece, can be shortened and the performance efficiency of cutting the wood can be improved by switching the rotational speed ω of the motor 10 to the high speed when the blade 9 comes into contact with the wood.

The first mode is thus suitable for processing a wood, where the blade 9 does not slip at the beginning of the processing, since the rotational speed ω of the motor 10 is switched in two steps, the low speed and the high speed.

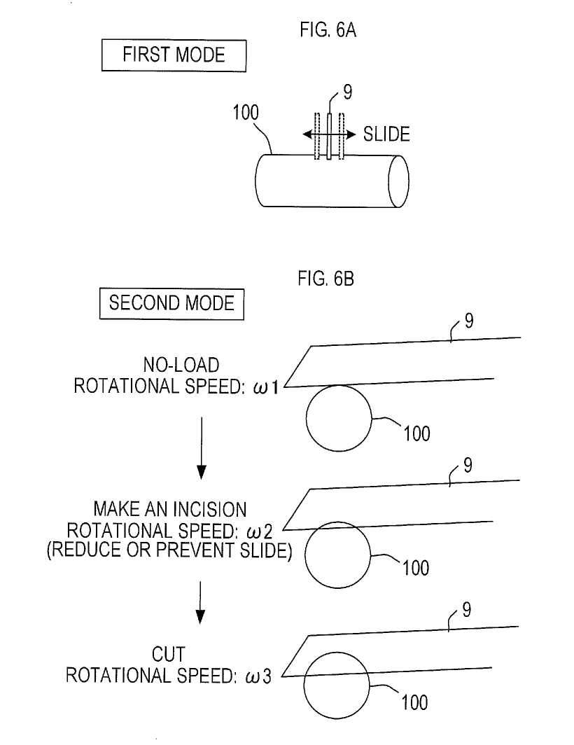

However, if the motor 10 is controlled in the first mode in a case of cutting an iron pipe 100, then the rotational speed ω of the motor 10 is switched to the high speed when the blade 9 comes into contact with the iron pipe 100 and the torque τ of the motor 10 increases; the blade 9 then oscillates in a direction perpendicular to a plate surface of the blade 9 and slides on the surface of the iron pipe 100 as illustrated in FIG. 6A. Consequently, the iron pipe 100 cannot to be cut efficiently.

In such a case, the operational mode can be set to the second mode in the reciprocating saw 2 in the present embodiment, in addition to the aforementioned normal mode and first mode.

In the second mode, the rotation of the motor 10 is controlled stepwise in three steps based on the state quantity (the torque τ in the present embodiment) that indicates the load state of the motor 10, the three steps being the first speed ω1, the second speed ω2, and the third speed ω3.

Thus, effects (1) to (3) as described below can be attained when cutting the iron pipe 100 as illustrated in FIG. 6B if the user sets the operational mode of the reciprocating saw 2 to the second mode by operating the operation-setting unit 22.

(1) The oscillation of the motor 10 can be reduced to decrease an occurrence of a sound or a radio noise as well as to reduce the consumed electric power generated from the drive of the motor 10 by controlling the rotational speed ω of the motor 10 to be the first speed ω1 during the no-load time, which is from when the trigger switch 16 is operated until when the blade 9 comes into contact with the iron pipe 100 and the torque τ of the motor 10 exceeds the first threshold value τ1.

(2) The rotational speed ω of the motor 10 can be controlled to be the second speed ω2 that is suitable for making an incision on the iron pipe 100 so as to reduce or prevent a slide of the blade 9 on the surface of the iron pipe 100 during a time from when the blade 9 comes into contact with the iron pipe 100, and an incision is made on the iron pipe 100, and the user presses the blade 9 against the iron pipe 100 to cut the iron pipe 100, until when the torque τ of the motor 10 exceeds the second threshold value τ2.

(3) A performance efficiency of cutting the iron pipe 100 can be improved by controlling the rotational speed ω of the motor 10 to be the third speed ω3 that is suitable for cutting the iron pipe 100 to shorten the time required for cutting the iron pipe 100 when the torque τ of the motor 10 exceeds the second threshold value τ2.

In the above case, the user does not need to manually adjust the rotational speed ω of the motor 10 in accordance with the processing state of a metal material such as the iron pipe 100; thus, the performance of cutting-processing the metal material can be improved.

In the present embodiment, the trigger switch 16 is not only configured to input the drive command of the reciprocating saw 2 (thus, of the motor 10), but also configured to be capable of setting the rotational speed ω of the motor when in the normal mode as well as the upper-limit of speed of the motor 10 when in the control mode (in the first mode or in the second mode) in accordance with the pulled amount of the trigger switch 16.

Thus, according to the reciprocating saw 2 of the present embodiment, the user can use the reciprocating saw 2 safely, since the motor 10 is restricted or prevented from being driven in excess of the rotational speed ω specified by the user via the trigger switch 16.

In the present embodiment, if the torque τ that indicates the load state of the motor 10 is decreased to the third threshold value τ3, which is lower than the first threshold value τ1, when the motor 10 is being driven at the third speed ω3, then the motor is driven at the first speed ω1.

In other words, in the present embodiment, once the rotational speed ω of the motor 10 is increased to the third speed ω3, the motor 10 is continued to be driven without reducing its speed until the torque τ is equal to or smaller than the third threshold value τ3.

Thus, for example, it can reduce a level difference or the like, which is unexpected for the user, being formed on the cut surface of the iron pipe 100 as a result of a fall of the rotational speed ω of the motor 10 from the third speed ω3 to the second speed ω2 when the torque τ is decreased to the second threshold value τ2 due to a sudden release of the user's tension when cutting the iron pipe 100.

That is to say that, the rotational speed ω of the motor 10 can be maintained at the third speed ω3 when processing the metal material according to the reciprocating saw 2 of the present embodiment; it thus becomes easy to process the metal material as intended by the user.

Also, according to the reciprocating saw 2 of the present embodiment, the rotational speed ω of the motor 10 is decreased to the first speed ω1 by the processes from S260 to S310 if the torque τ of the motor 10 falls below the third threshold value without reaching the second threshold value τ2.

According to the present embodiment, it is thus possible to reduce the consumed electric power in a case where the torque τ of the motor 10 does not reach the second threshold value τ2 after the drive of the motor 10 is started.

In the present embodiment, the blade holder 8 corresponds to one example of the attachment unit of the present invention; the controller 20 corresponds to one example of the controller of the present invention; the monitor circuit 18 corresponds to one example of the load-state detection unit of the present invention; and, the trigger switch 16 corresponds to one example of the speed-setting unit of the present invention.

Although an exemplary embodiment of the present invention was explained hereinbefore, the present invention is not limited to the aforementioned embodiment and can take various modes without departing from the range of the spirit of the present invention.

(Modification 1)

The aforementioned embodiment, for example, explained that the operation-setting unit 22 was configured with the selector switch that could switch the position of the operation unit 24 in three modes so as to set the operational mode of the reciprocating saw 2 to any of the normal mode, the first mode, or the second mode.

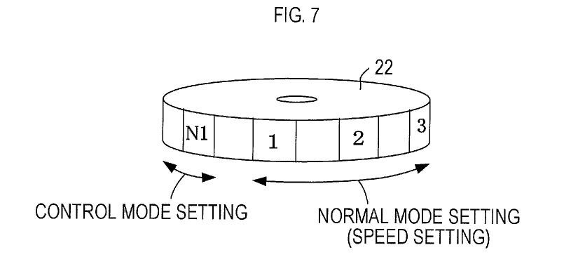

However, the operation-setting unit 22 may also be configured with a rotary switch as illustrated in FIG. 7 so as to select the control mode from the first mode N1 and the second mode N2 (not shown); and to select the normal mode from a plurality of modes (the normal mode 1, the normal mode 2, the normal mode 3 . . . ) having different target speeds for the motor 10 in accordance with the rotated position of the rotary switch.

In this case, if the drive command is inputted via the trigger switch 16 or the like when one of the normal modes 1, 2, or 3 is selected, the motor 10 may be driven at the target speed corresponding to the selected normal mode.

(Modification 2)

The aforementioned embodiment also explained that the rotational speed ω of the motor 10 was switched stepwise between the preset target speed ω01 and ω02, or, between the first speed ω1, the second speed ω2, and the third speed ω3 when the operational mode of the reciprocating saw 2 was set to the first mode or the second mode of the control mode.

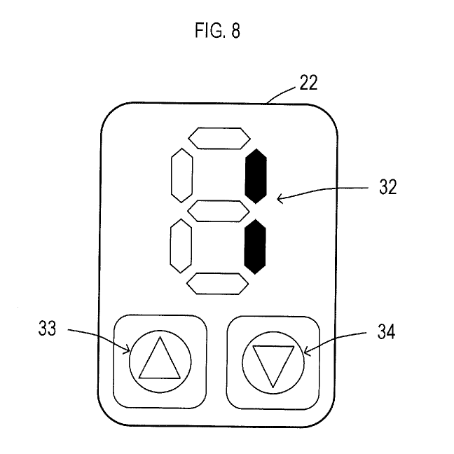

However, a control-parameter setting unit 30 as illustrated in FIG. 8 may be provided so that the user can appropriately set such control parameters as the rotational speeds ω01, ω02, ω1, ω2, and ω3 of the motor 10; and the threshold valueτ01, τ02, τ1, τ2, and τ3 of the torque τ that is used for determining to change the rotational speed.

The control-parameter setting unit 30 illustrated in FIG. 8 is configured with a seven-segment numeric display unit 32 and two operation push-buttons 34 that change and decide the numerical value so that a type of the control parameter to be set and a value of the selected control parameter can be chosen from 10 types at most using numerical values from 0 (zero) to 9.

Note that this configuration is one example; the control-parameter setting unit 30 may be anything to which the user can input the control parameter.

(Modification 3)

The aforementioned embodiment explained next that, when the operational mode of the reciprocating saw 2 was in the second mode, the rotational speed ω of the motor 10 was increased to the third speed ω3 in the loaded mode 2 once, then the loaded mode 2 was maintained until the torque τ is decreased to the third threshold value τ3; the rotational speed ω of the motor 10 was brought back to the first speed ω1 in the no-load mode when the torque τ was equal to or smaller than the third threshold value τ3.

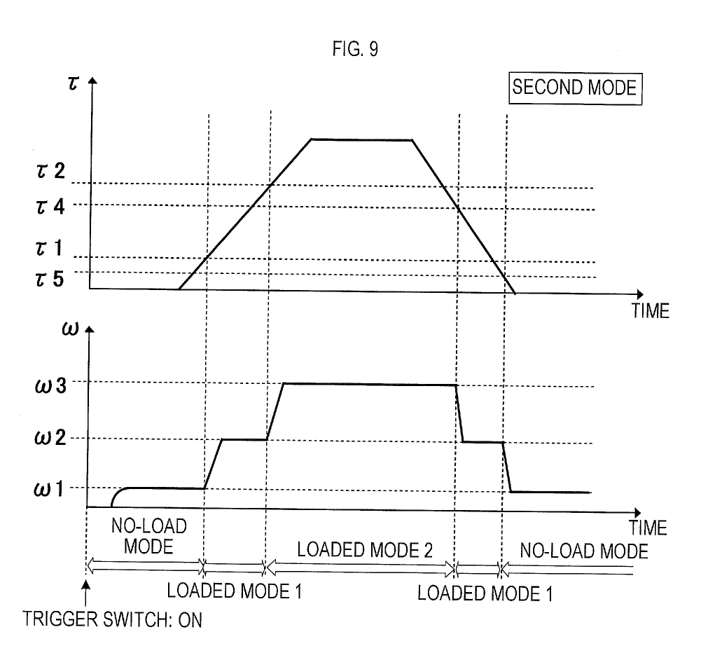

However, as illustrated in FIG. 9, after the rotational speed ω of the motor 10 is increased to the third speed ω3 in the loaded mode 2, the rotational speed ω of the motor 10 may be brought back to the second speed ω2 in the loaded mode 1 when the torque τ is equal to or smaller than a fourth threshold value τ4, which is a value between the second threshold value τ2 and the first threshold value τ1; then the rotational speed ω of the motor 10 may further be brought back to the first speed ω1 in the no-load mode when the torque τ is equal to or smaller than a fifth threshold value τ5, which is a value smaller than the first threshold value τ1.

As a result of the above, when the torque τ of the motor 10 is decreased, the rotational speed ω of the motor 10 can be decreased stepwise in the reverse direction of the steps for when the torque τ of the motor 10 is increased as the metal material is processed.

In such case, a sharp decrease of the rotational speed ω of the motor 10 can therefore be restrained or prevented when finishing processing of the metal material; thus, the performance of processing can be improved by, for example, reducing the oscillation of the blade 9 which is caused when the metal material is repeatedly processed.

(Modification 4)

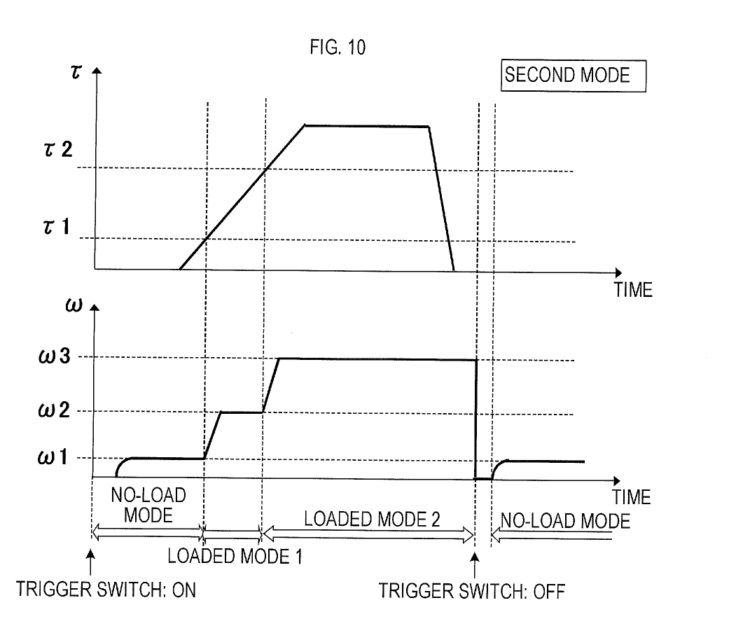

As illustrated in FIG. 10, when the rotational speed ω of the motor 10 is increased to the third speed ω3 in the loaded mode 2 once, the rotational speed ω of the motor 10 may be maintained at the third speed ω3 in the loaded mode 2 until it is determined that the trigger switch 16 is in the OFF state and the operation-stop command of the motor 10 is inputted; the drive of the motor 10 may then be stopped when the trigger switch 16 is in the OFF state.

The above-mentioned control may be applied to a jigsaw. That is to say that, the blade is occasionally removed from the metal plate for a moment to change an angle of the blade in relation to the metal plate when drawing a curve on a metal plate with the jigsaw; the motor is in no-load condition during such a moment. In this case, if the rotational speed ω of the motor is decreased to the first speed ω1 every time when the motor is in no-load condition, the performance of processing is noticeably degraded for the user.

However, as illustrated in FIG. 10, if the rotational speed ω of the motor 10 is controlled, then the rotational speed ω of the motor 10 is maintained at the third speed ω3 until the trigger switch 16 is turned off; therefore, degradation in performance of processing the metal plate with the jigsaw can be reduced.

(Modification 5)

The aforementioned embodiment explained next that the rotational speed ω of the motor 10 was increased stepwise in three steps from the first speed ω1 to the third speed ω3 when the operational mode of the reciprocating saw 2 was in the second mode.

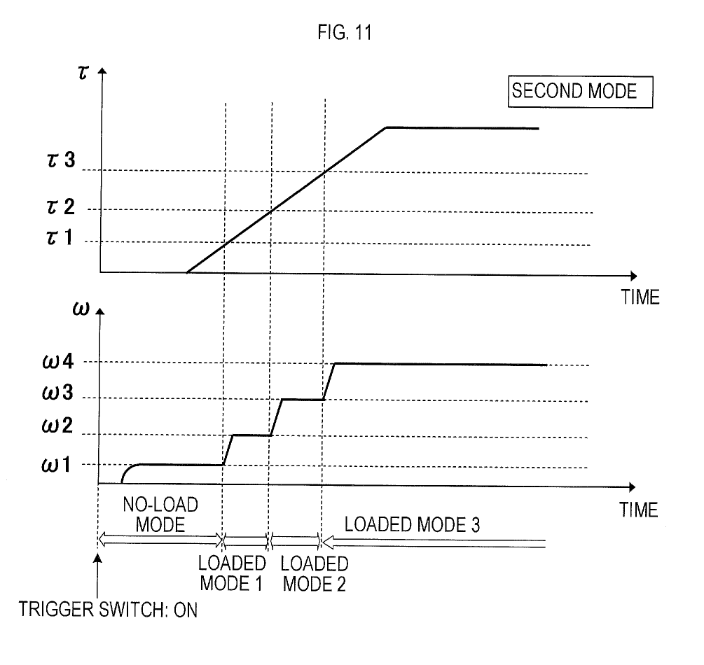

However, the rotational speed ω of the motor 10 may be increased stepwise from the first speed ω1 to the second speed ω2, to the third speed ω3, and to the forth speed ω4 every time the torque τ of the motor 10 exceeds the three threshold value from the first threshold value τ1 to the third threshold value τ3 as illustrated in FIG. 11 when the operational mode of the reciprocating saw 2 is in the second mode, or, when the operational mode of the reciprocating saw 2 is in a new third mode.

As a result of the above, the reciprocating electric power tool such as the reciprocating saw 2 can switch the rotational speed ω of the motor 10 more finely in accordance with the processing state of the work piece, and thus can improve the processing accuracy of the work piece.

In this case, a method of decreasing the rotational speed ω of the motor 10 after increasing the rotational speed ω of the motor 10 to the forth speed ω4 in the loaded mode 3 may be the same as the aforementioned embodiment, or as the modifications 3 and 4.

In a case where the rotational speed ω of the motor 10 is changed stepwise as mentioned above, the number of speed change steps may be three steps as in the aforementioned embodiment, or four steps as in the modification 5, or greater than 4 steps.

(Modification 6)

The aforementioned embodiment and modifications explained that the conditions to switch the rotational speed ω of the motor 10 were to increase the rotational speed ω of the motor 10 stepwise when the torque τ exceeded the first threshold value τ1, which was the first condition, and when the torque τ exceeded the second threshold value τ2, which was the second condition, by using the torque τ of the motor 10 that was estimated via the monitor circuit 18.

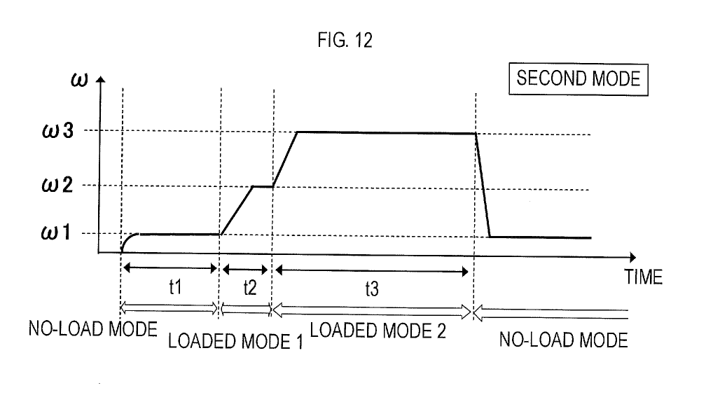

However, such conditions (the first condition and the second condition) may be set based on the drive time (the first-time t1, the second-time t2, and the third-time t3 as shown in FIG. 12) of the motor 10 since the start of the drive as illustrated in FIG. 11.

As a result of the above, the estimation of the torque τ by the monitor circuit 18 is not necessary; thus, the cost may be reduced by simplifying the device configuration compared to the aforementioned embodiment.

In a case where the state quantity that indicates the load state of the motor 10 is used as a condition to switch the rotational speed ω of the motor 10, it is not always necessary to use the torque τ of the motor 10 as the state quantity as in the aforementioned embodiment. The current that flows in the motor 10, the rotational speed of the motor 10, or the combination of these may be used as the state quantity.

The aforementioned embodiment explained that the torque τ and the rotational speed ω of the motor 10 were estimated based on the current and voltage of the motor 10 by using the monitor circuit 18 and were used to control the drive of the motor 10. However, the torque τ and the rotational speed ω of the motor 10 may be directly detected by using a torque sensor and a rotation sensor.

Also, a parameter, which is different from the state quantity that indicates the load state of the motor 10 or from the elapsed time since the drive of the motor 10 is started, may be used as the condition to switch the rotational speed ω of the motor 10. Alternatively, the rotational speed ω of the motor 10 may be switched stepwise in accordance with a speed-change command that is inputted by the user through operating the operation switch.

The aforementioned embodiment and modifications explained that the present invention could be applied to a reciprocating saw or a jigsaw. However, likewise the aforementioned embodiment, the present invention can also be applied to any electric power tool, as long as it is an electric power tool that processes a work piece by reciprocating a tool bit,.

The aforementioned embodiment and modifications explained that the threshold value to decrease the rotational speed ω (in other words, the condition to switch the rotational speed) of the motor 2 was set to a value different from the threshold value to increase the rotational speed ω of the motor 2. However, the threshold value to decrease the rotational speed ω of the motor 2 may be set to the same value as the threshold value to increase the rotational speed ω of the motor 2. For example, in the case of the aforementioned embodiment, the first threshold value τ1 and the third threshold value τ3 may be set to the same value.

(Modification 7)

The aforementioned embodiment and modifications, the trigger switch 16 may be equipped with a lock-on mechanism 17 (see, FIG. 1), which holds the trigger switch 16 with the maximum pulled amount.

In brief, according to the aforementioned embodiment, the rotational speed of the motor 10 can be switched to two or more steps from the rotational speed of the no-load time after activation; thus, a subtle adjustment of the speed by the trigger switch 16 is unnecessary.

Therefore, according to the aforementioned embodiment, although the trigger switch 16 is held with the maximum pulled amount by the function (the lock-on function) of the lock-on mechanism 17 comprised in the trigger switch 16, the work piece can still be processed effectively and required work in processing the work piece can still be performed effectively.

1. A reciprocating electric power tool comprising:
an attachment unit to which a tool bit for processing a work piece by reciprocating is attached;
a motor that makes the attachment unit to reciprocate;
a power transmission unit that is configured to convert a rotation of the motor into a reciprocating motion and to make the attachment unit to reciprocate; and,
a controller that is configured to operate the motor in accordance with a command from outside,
wherein the controller is configured to operate the motor at a first speed when activated; to operate the motor at a second speed that is higher than the first speed when a first condition is satisfied after activation; and, to operate the motor at a third speed that is higher than the second speed when a second condition is satisfied after the first condition is satisfied.

2. The reciprocating electric power tool according to claim 1,
the reciprocating electric power tool comprising a load-state detection unit that is configured to detect a state quantity indicating load state of the motor,
wherein the controller is configured
to set at least a first threshold value and a second threshold value that is greater than the first threshold value for a state quantity detected by the load-state detection unit;
to determine that the first condition is satisfied when the state quantity reaches the first threshold value when operating the motor at the first speed, and operate the motor at the second speed; and,
to determine that the second condition is satisfied when the state quantity reaches the second threshold value when operating the motor at the second speed, and operate the motor at the third speed.

3. The reciprocating electric power tool according to claim 1,
wherein the controller is configured
to set at least a first-time and a second-time;
to determine that the first condition is satisfied when the first-time has elapsed when operating the motor at the first speed, and operate the motor at the second speed; and,
to determine that the second condition is satisfied when the second-time has elapsed when operating the motor at the second speed, and operate the motor at the third speed.

4. The reciprocating electric power tool according to claim 1,
the reciprocating electric power tool comprising a speed-setting unit that sets a rotational speed of the motor,
wherein the controller is configured to limit the rotational speed of the motor to a rotational speed set by the speed-setting unit or lower when operating the motor regardless of whether the first condition or the second condition is satisfied.

5. The reciprocating electric power tool according to claim 2,
wherein the controller is configured to operate the motor at the first speed when the state quantity decreases to a third threshold value that is equal to or lower than the first threshold value when operating the motor at the third speed.

6. The reciprocating electric power tool according to claim 1,
wherein the controller is configured to continue operation of the motor until an operation-stop command for the motor is inputted and to stop operation of the motor when the operation-stop command for the motor is inputted when operating the motor at the third speed.

7. The reciprocating electric power tool according to claim 5,
wherein the controller is configured
to operate the motor at the second speed when the state quantity is decreased to a fourth threshold value that is equal to the second threshold value or between the second threshold value and the third threshold value when operating the motor at the third speed; and,
to operate the motor at the first speed when the state quantity is decreased to a third threshold value that is equal to or lower than the first threshold value when operating the motor at the second speed.

8. The reciprocating electric power tool according to claim 1,
wherein the controller is configured to operate the motor at the first speed when an elapsed time for operating the motor at the third speed reaches a preset time.

9. The reciprocating electric power tool according to claim 1,
the reciprocating electric power tool further comprising a control-parameter setting unit that sets a control parameter, used for the controller to control operation of the motor, from outside.

10. The reciprocating electric power tool according to claim 1,
wherein the controller is configured to be operable also in a normal mode where the motor is operated at a specified rotational speed in accordance with a command from outside in addition to a control mode where rotational speed of the motor is switched in accordance with the first condition or the second condition,
the reciprocating electric power tool further comprising an operation-setting unit that sets an operational mode of the controller either to the control mode or to the normal mode.

11. The reciprocating electric power tool according to claim 1,
the reciprocating electric power tool further comprising a trigger switch that is configured to provide the controller with a command for rotational speed of the motor based on a pulled amount of the trigger switch as well as a command for operation of the motor,
wherein the trigger switch comprises a lock-on function that holds the trigger switch with a maximum pulled amount.

12. The reciprocating electric power tool according to claim 2,
wherein the load-state detection unit is configured to calculate a state quantity that indicates a load state of the motor by using at least one of a current, rotational speed, or torque of the motor.
